(19) United States
(12) Patent Application Publication
(10) Pub. No.: US 2006/0246207 A1
(43) Pub. Date: Nov. 2, 2006

(54) Sucralose sweetening composition

(76) Inventor: Barnard Stewart Silver, Holladay, UT (US)

Correspondence Address: BRINKS HOFER GILSON & LIONE, P.O. BOX 10395, CHICAGO, IL, 60610, US

(21) Appl. No.: 11/435,649

(22) Filed: May 16, 2006

Related U.S. Application Data
(63) Continuation-in-part of application No. 10/443,935, filed on May 22, 2003, now Pat. No. 7,045,166.
Application No. 10/443,935 is a continuation-in-part of application No. 10/037,027, filed on Nov. 9, 2001, now Pat. No. 6,569,488.
Application No. 10/037,027 is a continuation-in-part of application No. 09/716,780, filed on Nov. 20, 2000, now Pat. No. 6,419,978.
Application No. 09/716,780 is a continuation-in-part of application No. 09/553,973, filed on Apr. 20, 2000, now abandoned.
Application No. 09/553,973 is a continuation-in-part of application No. 09/379,952, filed on Aug. 24, 1999, now Pat. No. 6,399,142.
(60) Provisional application No. 60/098,195, filed on Aug. 27, 1998.
(60) Provisional application No. 60/104,091, filed on Oct. 13, 1998.
(60) Provisional application No. 60/686,829, filed on May 26, 2005.

(51) Int. Cl. A23G 3/00

(52) U.S. Cl. 426/658

(57) ABSTRACT

A sweetener composition containing sucralose and having improved thermal stability comprising particles containing substantially non-crystalline sucralose mixed with inulin. The composition can be prepared by forming a co-solution of the sucralose and inulin in water which is then dried. Other ingredients such as other high intensity sweeteners, sugar alcohols, and flavorings also may be included.

### RELATED APPLICATIONS

This application is a continuation-in-part of application Ser. No. 10/443,935, now U.S. Pat. No. 7,045,166, which is a continuation-in-part of application Ser. No. 10/037,027, now U.S. Pat. No. 6,569,488, which is a continuation-in-part of Ser. No. 09/716,780, now U.S. Pat. No. 6,419,978, which is a continuation-in-part of Ser. No. 09/553,973, filed Apr. 20, 2000, now abandoned, which is a continuation-in-part of application Ser. No. 09/379,952, now U.S. Pat. No. 6,399,142, the latter of which claims priority to provisional applications Ser. No. 60/098,195, filed Aug. 27, 1998, and Ser. No. 60/104,091, filed Oct. 13, 1998. The present application claims priority to U.S. Provisional Patent Application, Ser. No. 60/686,829, filed Mar. 26, 2005.

### FIELD OF THE INVENTION

This invention relates to sweetener compositions containing intimate mixtures of sucralose and water soluble fractions of inulin, and methods of preparing same.

### BACKGROUND

Sucralose is a water soluble, non-caloric sweetener at least about 600 times sweeter than sugar. Sucralose is known as an “intense sweetener.” There are several problems to using sucralose to replace sugar. Because it is an intense sweetener, it benefits in many uses in combination with a bulking agents, such as maltodextrin and/or dextrose, to reduce the sweetness.

Another problem occurs when heating sucralose to elevated temperatures. Sucralose alone, at elevated temperature, changes from a white to a deep chocolate brown color. This change in color indicates decomposition of the sucralose molecule, resulting in substantial reductions in the high intensity sweetness.

Still another problem arises with the high intensity sweetener sucralose. Due to the high intensity sweetness of sucralose, it is difficult to uniformly disperse sucralose throughout any bulking agent by mechanical mixing. The result of mechanical mixing is parts of the mixture are sweeter than others.

Raw inulin contains fractions that tend to congeal in parts of spray drying equipment at elevated temperatures. For that reason, raw inulin tends to be inflexible in spray drying processes.

By “inulin” refers to polysaccharides that are obtained by the extraction of inulin from inulin containing plant materials, such as, chicory root, Jerusalem artichoke, agave, and other plant materials, as disclosed in U.S. Pat. No. 6,569,488. Inulin fractions can be made, for example, using the processes disclosed in U.S. Pat. No. 6,569,488, and the processes for making the water soluble inulin fractions are preferred.

By “fractions of inulin” is meant admixtures of at least two, preferably at least three, desirably at least four fructo-polysaccharides, but less than all of the fructo-polysaccharides extracted from plant materials containing inulin.

By “water soluble inulin fractions” is meant polysaccharides of inulin that are soluble in water in amounts of at least about 5 grams per 100 milliliters (ml) of water (≦0.05 w/v), preferably at least about 10 grams per 100 ml of water (≦0.1 w/v), desirably at least about 20 grams per 100 ml of water (≦0.2 w/v), at temperatures in the range from about 10° C. to about 25° C. Examples of water soluble inulin fractions are the fructo-polysaccharides of inulin in which at least about 75% by weight of said polysaccharides have molecular weights of about 2288 and below.

By “clumps” is meant discrete groups of materials having average diameters usually ranging from about 0.01 mm to about 4.0 mm.

By “sweetener clumps” is meant clumps in which the materials in the clumps comprise sucralose and inulin. Other ingredients such as other high intensity sweeteners, sugar alcohols, and flavorings may also be included.

Sucralose is reported to be very stable at high temperatures in foods and beverages in which it is dispersed at relatively low concentrations. However, pure, dry, crystalline sucralose is reported to be rather less stable to high temperatures.

### DETAILED DESCRIPTION OF THE INVENTION

This invention relates to sucralose sweetener compositions, including sucralose sweetener concentrates, comprising the high intensity sweetener sucralose (4,1′, 6′-trichloro-4,1′,6′-trideoxygalactosucrose) and water soluble inulin. The many uses of sucralose as a sweetener are well known.

It is a discovery of the present invention that crystalline sucralose loses its high intensity sweetness when heated to elevated temperatures for a period of time. However, if sucralose is spray-dried or freeze-dried with water soluble inulin, the sucralose and inulin form clumps and the high sweetness of sucralose is retained.

For example, when pure, dry crystalline sucralose is maintained near 80° C., the color changes from white colorless to pale brown after about 20 minutes (See Example 6). Over long periods at temperatures above about 40° C. significant degradation of sucralose may occur.

The present invention relates to the fact that the sweetness of sucralose is greatly preserved when it is intimately combined with water soluble inulin by co-drying. A preferred embodiment is a co-dried sweetener comprising sucralose and inulin in the ratios of about 1:600 to 1:1 by weight.

In contrast, it has been indicated (U.S. Pat. No. 4,927,646) that a simple dry mixture of crystalline sucralose and maltodextrin that contains 33.8% sucralose by weight showed some loss of sucralose after 25 days storage at 45° C. Also, it has been reported that pure, dry crystalline sucralose itself discolors after about one week at 45° C. with measurable losses of sucralose after about three to four weeks. The simple dispersal of the sucralose particles with maltodextrin is reported to not provide a satisfactory product, although it is reported that the mixture does enhance the thermostability of sucralose to some extent.

A highly thermostable sweetener composition according to the present invention may be achieved by a variety of conventional methods, including spray-drying or freeze-drying of solutions of sucralose and inulin.

Sucralose alone cannot be spray-dried, because it melts and adheres to the internal surfaces of the spray drier. However, aqueous co-solutions of sucralose and water soluble inulin can be spray-dried satisfactorily at sucralose to inulin weight ratios up to as high as about 600:1 by weight water soluble inulin to sucralose.

The present invention is directed to the discovery that, upon drying sucralose and water soluble inulin that have been previously dissolved, or suspended, in water, a noncrystalline form of sucralose will be dispersed evenly throughout the particles of the dried product and intimately mixed with the inulin.

Thus, according to the present invention there is provided a sweetener comprising sucralose mixed with inulin in water and dried to a product..

The sweetener of the present invention may optionally contain other water-dispersible ingredients such as other high intensity sweeteners, lactose, sugar alcohols, and flavourings. In particular, sweetener concentrates comprising synergistic combinations of sucralose with other high intensity sweeteners such as saccharin, acesulfame-K, aspartame, and sugar alcohols are of interest.

The invention may be illustrated further by the following non-limiting examples, as listed below.

### EXAMPLE 1

### 100 Parts of Water Soluble Inulin to 1 Part of Sucralose

200 grams of water soluble inulin and 2 grams of sucralose were mixed in 1 liter of distilled water at room temperature. This 20.2% mixture of solids to water was spray dried at an inlet temperature of 165° C. and an average outlet temperature of 86° C. The product was in the form of light fluffy clumps and had a bulk density of 0.24 grams per cubic centimeter.

The too sweet white fluffy clumps were placed in a CENCO oven at 79° C., held for 23 minutes with the oven temperature being raised continuously to 87° C. The spray dried sample was observed to retain its white color and fluffy clump form.

The sample was again heated from 77° C. to 84° C. for 8 minutes. The sample was reinspected and observations made that the white color was still present as was the fluffy clump form.

The sample was held for a third period of time at 8 minutes at 82° C. The sample was again inspected and observed to have the same white color as originally and the fluffy clump form.

The sample was then kept at laboratory heater temperature of 18° C. for 11 days and final inspection established that the white color was maintained along with its too sweet taste.

### EXAMPLE 2

### 10 Parts of Water Soluble Inulin to 1 Part of Sucralose

150 grams of water soluble inulin and 15 grams of sucralose were mixed in 0.5 liters of distilled water at room temperature. This 33% mixture was spray dried at an inlet temperature of 165° C. and an average outlet temperature of 90° C. The produce was in the form of light fluffy clumps and had a bulk density of 0.23 grams per cubic centimeter.

The far too sweet white fluffy clumps were placed in a CENCO oven at 79° C., held for 23 minutes with the oven temperature being raised continuously to 87° C. The spray dried sample was observed to retain its white color.

The sample was again heated from 77° C. to 84° C. for 8 minutes. The spray dried sample was observed to retain its white color and fluffy clump form.

The sample was again heated from 77° C. to 84° C. for 8 minutes. The sample was reinspected and observations made that the white color was still present as was the fluffy clump form.

The sample was held for a third period of time at 8 minutes at 82° C. The sample was again inspected and observed to have the same white color as originally and the fluffy clump form.

The sample was then kept at laboratory heater temperature of 18° C. for 11 days and final inspection established that the white color was maintained along with its far too sweet taste.

### EXAMPLE 3

### 300 Parts of Water Soluble Inulin to 1 Part of Sucralose

To the one half liter of the liquid mixture remaining from Example 1 was added 79.996 grams of water soluble inulin at room temperature. This 33% mixture was spray dried at an inlet temperature of 165° C. and an average outlet temperature of 82° C. The product was in the form of light fluffy clumps and had a bulk density of 0.23 grams per cubic centimeter.

The overly sweet white fluffy clumps were placed in a CENCO oven at 79° C., held for 23 minutes with the oven temperature being raised continuously to 87° C. The spray dried sample was observed to retain its white color and fluffy clump form.

The sample was again heated from 77° C. to 84° C. for 8 minutes. The sample was reinspected and observations made that the white color was still present as was the fluffy clump form.

The sample was held for a third period of time at 8 minutes at 82° C. The sample was again inspected and observed to have the same white color as originally and the fluffy clump form.

The sample was then removed from the laboratory heater and kept in a room that varied in temperature and humidity for 11 days and final inspection established that the white color was maintained along with its overly sweet taste.

### EXAMPLE 4

### 600 Parts of Water Soluble Inulin to 1 Part of Sucralose

165 grams of water soluble inulin and 0.275 grams of sucralose were mixed in 500 milliliters of distilled water at room temperature. This 33% mixture was spray dried at an inlet temperature of 165° C. and an average outlet temperature of 85° C. The product was in the form of light fluffy clumps and had a bulk density of 0.27 grams per cubic centimeter.

The sweet (equal to the sweetness of sucrose to the experimenter's taste) white fluffy clumps were put in a CENCO oven at 79° C., held for 23 minutes with the oven temperature being raised continuously to 87° C. The spray dried sample was observed to retain its white color and fluffy clump form.

The sample was again heated from 77° C. to 84° C. for 8 minutes. The sample was reinspected and observations made that the white color was still present as was the fluffy clump form.

The sample was held for a third period of time at 8 minutes at 82° C. The sample was again inspected and observed to have the same white color as originally and the fluffy clump form.

The sample was then kept at laboratory heater temperature of 18° C. for 11 days and final inspection established that the white color was maintained along with its sweet taste.

### EXAMPLE 5

### 2 Parts of Water Soluble Inulin to 1 Part of Sucralose

44.4 grams of water soluble inulin and 22.2 grams of sucralose were mixed in 200 milliliters of distilled water at room temperature. This 33% mixture was spray dried at an inlet temperature of 165° C. and an average outlet temperature of 84° C. The product was in the form of light fluffy clumps and had a bulk density of 0.25 grams per cubic centimeter.

The intolerably sweet white fluffy clumps were placed in a CENCO oven at 79° C., held for 23 minutes with the oven temperature being raised continuously to 87° C. The spray dried sample was observed to retain its white color and fluffy clump form.

The sample was again heated from 77° C. to 84 for 8 minutes. The sample was reinspected and observations made that the white color was still present as was the fluffy clump form.

The sample was held for a third period of time at 8 minutes at 82° C. The sample was again inspected and observed to have the same white color as originally and the fluffy clump form.

The sample was then kept at laboratory heater temperature of 18° C. for 11 days and final inspection established that the white color was maintained along with its intolerably sweet taste.

### EXAMPLE 6

### Sucralose, as Purchased, was Weighed and Found to have a Bulk Density of 0.7 Grams per Cubic Centimeter

The intolerably sweet white powder sucralose was placed in a CENCO oven at 79° C., held for 23 minutes with the oven temperature being raised continuously to 87° C. Upon inspection, the sucralose on the heating tray for the bottom ½ of the little pyramid was an almost milk-chocolate brown color and the white powder had turned into small brown granules. The top ½ was still the white powder.

The sample was again heated from 77° C. to 84° C. for 8 minutes. Inspection of the sucralose on the heating tray for the bottom 0.9 of the little pyramid was a milk-chocolate brown color small granules and the top 0.1 was white powder.

The sample was held for a third period of time at 8 minutes at 82° C. The sample was again inspected and observed to be between a milk-chocolate and dark-chocolate brown color much smaller granule pyramid.

The sample was then kept at laboratory heater temperature of 18° C. for 11 days and final inspection established that the color between a milk-chocolate and dark-chocolate brown was maintained. The granular form was also maintained. Most importantly, the intolerably sweet taste was gone. The after-heating sucralose was no sweeter than sucrose, the conventional table-top sugar.

As seen by analyzing Examples 1-5, a co-dried non-crystalline product containing water soluble inulin retains its sweetness (See Examples 1-5). However, sucralose alone (See Example 6) loses its sweetness at elevated temperatures.

The ratio of inulin to sucralose can range from about 600:1 to about 1:1 parts by weight.

While not wishing to be bound by any theory, the inulin seems to protect the sucralose against degradation, for example, sweetness degradation, over a wide ratio range.

1. A sweetener composition comprising plurality of sweetener clumps, said sweetener clumps comprising substantially noncrystalline sucralose and water soluble fractions of inulin, said water soluble inulin comprising fractions having water solubility of at least about 5 grams per 100 ml of water at temperatures from about 10° C. to about 25° C.

2. The sweetener composition of claim 1, in which said inulin comprises water soluble fractions having water solubility of at least about 10 grams per 100 ml of water at temperatures from about 10° C. to about 25° C.

3. The sweetener composition of claim 1, in which said inulin comprises water soluble fractions having water solubility of at least about 20 grams per 100 ml of water at temperatures from about 10° C. to about 25° C.

4. A sweetener concentrate comprising a plurality of sweetener clumps, said clumps comprising substantially noncrystalline sucralose mixed with water soluble inulin, and in which the ratio of sucralose to inulin is from 1:600 to 1:1 on a dry weight basis.

5. A method for preparing a sweetener composition containing sucralose and inulin comprising forming a water mixture of sucralose and water soluble inulin fractions, wherein said mixture comprises at least about 0.5 parts by weight of sucralose and about 600 parts by weight of such water soluble inulin.

6. The method of claim 5, in which said water mixture comprises from at least about 1 part by weight of sucralose and about 300 parts by weight inulin to about 1 part by weight sucralose to 1 part by weight of inulin.

7. The method of claim 5, in which the ratio of sucralose to water soluble fractions of inulin is from about 1:600 to 1:1 parts by dry weight basis.

8. The method of claim 5, in which the mixture further comprises one or more other water dispersible or soluble ingredients.

9. A sweetener comprising substantially noncrystalline sucralose and water soluble inulin co-dried together in sweetener clumps, said sweetener containing from at least about 0.166% by weight sucralose on a dry weight basis.
